(19) United States
(12) Patent Application Publication
(10) Pub. No.: US 2025/0292593 A1
(43) Pub. Date: Sep. 18, 2025

(54) DEVICE AND METHOD FOR PROVIDING MOVEMENT GUIDANCE BASED ON RECOGNITION OF ROAD STRUCTURE

(71) Applicant: ELECTRONICS AND TELECOMMUNICATIONS RESEARCH INSTITUTE, Daejeon (KR)

(72) Inventors: Jae-Yeong Lee, Daejeon (KR); Beom-Su Seo, Daejeon (KR); SeungHwan Park, Daejeon (KR); Seung-Ik Lee, Daejeon (KR); Seung Min Choi, Daejeon (KR)

(21) Appl. No.: 18/931,738

(22) Filed: Oct. 30, 2024

(30) Foreign Application Priority Data
Mar. 13, 2024 (KR) 10-2024-0035055

(51) Int. Cl. G06V 20/56; B60W 60/00; G06T 7/11; G06T 7/521

(52) U.S. Cl. CPC G06V 20/588; B60W 60/001; G06T 7/11; G06T 7/521; G06T 2207/10028

(57) ABSTRACT

There is provided a method of providing movement guidance based on road structure recognition. The method includes setting a movement mode corresponding to orientation indication that is input by a user, converting, into a depth image, three-dimensional (3-D) depth sensing data that have been input, recognizing information on the structure and direction of a road in the depth image, and determining a movement direction corresponding to the movement mode based on the recognized information on the structure and direction of the road.

### CROSS-REFERENCE TO RELATED APPLICATION(S)

This application claims priority to and the benefit under 35 USC § 119 of Korean Patent Application 'No. 10-2024-0035055 filed on Mar. 13, 2024, in the Korean Intellectual Property Office, the entire disclosures of which is incorporated herein by reference for all purposes.

### BACKGROUND

### 1. Technical Field

The present disclosure relates to a device and method for providing movement guidance based on road structure recognition.

### 2. Description of Related Art

In the past, a guide dog or a stick was commonly used as a device for assisting a person who is visually impaired. Such means may help a user to detect a surrounding environment and to prevent a collision against an object, but has some limits. In particular, such means has a disadvantage in that interactive communication is difficult because the means has a main function for unilaterally transferring information to a user.

Accordingly, a robot technology is recently introduced, and a guide robot for a person who is visually impaired has emerged. A robot for assisting a person who is visually impaired performs a function for identifying the location of a user based on a sensor and a map technology and suggesting a safe path or avoiding an obstacle by scanning a surrounding environment.

However, in a conventional technology, a robot cannot move if a map has not been previously constructed, for example. Accordingly, if a person who is visually impaired takes a new road, the conventional technology has a problem in that a service for a corresponding region is impossible. In this case, maintenance is necessary for the robot, but is also not easy. Accordingly, the conventional technology has a lot of difficulties in applying a common robot to a person who is visually impaired.

### SUMMARY

Various embodiments are directed to providing a device and method for providing movement guidance based on road structure recognition, which enable a robot for a person who is visually impaired to accurately recognize the structure and direction of a road based on sensor information and to provide the person who is visually impaired with guidance to a movement direction based on corresponding information, for a safe movement of the person who is visually impaired or the robot.

However, objectives of the present disclosure to be achieved are not limited to the aforementioned object, and other objects may be present.

A method of providing movement guidance based on road structure recognition includes setting a movement mode corresponding to orientation indication that is input by a user, converting, into a depth image, three-dimensional (3-D) depth sensing data that have been input, recognizing information on the structure and direction of a road in the depth image, and determining a movement direction corresponding to the movement mode based on the recognized information on the structure and direction of the road.

Furthermore, a device for providing movement guidance based on road structure recognition includes a movement mode setting unit configured to set a movement mode corresponding to orientation indication that is input by a user, a sensor input unit configured to receive three-dimensional (3-D) depth sensing data and to convert the 3-D depth sensing data into a depth image, a road information recognition unit configured to recognize information on the structure and direction of a road in the depth image, and a movement direction determination unit configured to determine a movement direction corresponding to the movement mode based on the recognized information on the structure and direction of the road.

Furthermore, a device for providing movement guidance based on road structure recognition includes an input unit configured to receive orientation indication from a user, a communication unit configured to receive three-dimensional (3-D) depth sensing data from a predetermined sensor, memory in which a program for providing guidance to a movement of the user has been stored based on the orientation indication, and a processor configured to set a movement mode corresponding to the orientation indication, convert the 3-D depth sensing data into a depth image, recognize information on the structure and direction of a road in the depth image, and determine a movement direction corresponding to the movement mode based on the recognized information on the structure and direction of the road.

A computer program according to another aspect of the present disclosure executes the device and method for providing movement guidance based on road structure recognition, and is stored in a computer-readable recording medium.

Other details of the present disclosure are included in the detailed description and the drawings.

According to the embodiments of the present disclosure, unlike in the existing technology in which a movement direction is determined based on a previously written map, a person who is visually impaired can be provided with guidance to a movement direction by checking the structure and direction of a surrounding road through a LiDAR or RGBD sensor even without a precise map. Accordingly, a person who is visually impaired can freely move to a desired road as the person uses the existing guide dog.

Furthermore, the device and method according to an embodiment of the present disclosure may also be implemented in a portable device not in a form in which the device and the method are mounted on a robot because the device and method can also be applied to a common LiDAR sensor in addition to a LiDAR sensor. Accordingly, a person who is visually impaired can be conveniently guided in the direction of a road by using a portable device even without a guide dog.

Moreover, the device and method according to an embodiment of the present disclosure may also be applied to the traveling of a conventional mobile robot without any change in addition to the guidance of a road for a person who is visually impaired. In this case, the mobile robot can safely move to a destination based on only navigation indication of a person or system even without a map.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a block diagram of a device for providing movement guidance based on road structure recognition according to an embodiment of the present disclosure.

FIG. 2 is a diagram illustrating an example of LiDAR sensor data.

FIG. 3 is a diagram illustrating an example in which three-dimensional (3-D) LiDAR sensing data are converted into a depth image.

FIG. 4 is a diagram illustrating an example of a 360-degree RGB image.

FIG. 5 is a diagram for describing a process of detecting a road region based on a depth image in an embodiment of the present disclosure.

FIG. 6 is a diagram illustrating an open space and a blocked region that have been divided in an embodiment of the present disclosure.

FIGS. 7A and 7B are diagrams illustrating a depth image, a LiDAR point cloud data graph, and a 360-degree RGB image in an embodiment of the present disclosure.

FIG. 8 is a block diagram of a movement guidance device according to an embodiment of the present disclosure.

FIG. 9 is a flowchart of a movement guidance method according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

Hereinafter, in order to help understanding of those skilled in the art, a contrived background of the present disclosure is first described and an embodiment of the present disclosure is then described.

In Korea, the number of persons who are visually impaired, but can go out alone by using a white stick is about 14,000 in 2021. They lost their eyesight due to visual impairments, but have the ability to locate themselves and move to their destinations by actively using residual senses (e.g., auditory, olfactory, tactile, and finely left vision) and to move to their destinations. However, although the person uses the ability, the person has to continuously knock and check around in order to check an obstacle, a bump, a step, and a boundary between a roadway and a sidewalk in a surrounding environment, which requires extreme concentration. The person experiences a feeling of extreme fatigue upon one going out due to such a continued surrounding detection process. Accordingly, a person who is visually impaired dislikes going out if it is not essentially required although the person is in a situation in which the person can go out for himself or herself.

As a conventional technology for assisting the walking of a person who is visually impaired, there has been released a smart stick product in which an ultrasonic sensor is mounted on a white stick and which transfers the presence of a surrounding obstacle in the form of vibration. However, the product is practically rarely used because the practicality of the product is limited due to too frequent alarm in a complicated sidewalk environment or at the center of a city. As another technology, there has been developed a technology in which a surrounding environment is perceived and explained to a user by using a camera, as in Seeing AI of Microsoft Corporation or Lookout of Google. However, such an app has a problem in that it may cause a person who is visually impaired to confuse a determination of his or her location and direction because the inflow of information is excessive. Furthermore, such apps have limits in terms of helping straight walking because the apps are basically focused on explaining a surrounding environment.

As one of effective means, there is a trained guide dog for a person who is visually impaired. The guide dog helps a person who is visually impaired to check his or her location and concentrate on his or her orientation, by assisting the avoidance of an obstacle and a safe straight walk. Accordingly, a person who is visually impaired determines a path up to a destination and a direction thereof by using residual senses. The guide dog plays a role of supporting a safe straight walk based on the orientation of the person who is visually impaired.

As described above, one of the most effective methods of supporting the walking of a person who is visually impaired is to use a trained guide dog, but the supply of trained guide dogs is now very smaller than the demand of trained guide dogs. Such a shortage is considered as a more serious problem because a lot of time and costs are consumed in training guide dogs. In Korea, the number of guide dogs that are currently active is about 80, which is about 1 out of every 3,125 persons who are visually impaired. In comparison, in the United States, one guide dog is used for 50 persons who are visually impaired (data of International Guide Dog Federation and the Samsung Fire & Marine Insurance Guide Dog School in 2022).

As an alternative for replacing insufficient guide dogs and assisting the walking of a person who is visually impaired, there is a robot guide dog technology using a mobile robot technology. Recently, research of a robot guide dog for a person who is visually impaired is actually carried out in some countries and research institutes. However, there are some problems in applying the conventional mobile robot technology to the guide dog robot for a person who is visually impaired.

In general, the mobile robot technology adopts a method of identifying the location of a robot by using a precise map and generating a path up to a destination. However, such a precise map-based technology requires a pre-constructed map, and there is a problem that it becomes difficult for robots to move in areas without this map. There is limitation in that although a person who is visually impaired knows a road, the person cannot use a robot if a corresponding area is not a service area. Furthermore, a lot of time and costs are consumed in writing a precise map, and there is a difficulty in that a map has to be rewritten or modified if a corresponding environment is changed. This acts as a more difficult task for a person who is visually impaired, and the maintenance of a precise map requires a complicated process. Furthermore, a precise map based on an image has a problem in that location recognition performance is greatly changed depending on weather when a map is written and used, a time zone (a day/a night), a season, and/or when a camera is used. Such problems cause a difficulty in effectively using a mobile robot to provide a person who is visually impaired with guidance.

In other words, the number of trained guide dogs is absolutely smaller than the demand for trained guide dogs. The existing smart stick or smart glasses is of little help in the straight walking of a person who is visually impaired. Furthermore, the conventional mobile robot technology has problems in that a lot of time and costs are consumed in writing and maintaining a precise map for a robot because a robot moves based on a pre-constructed precise map and the map needs to be rewritten or modified when a corresponding environment is changed.

In order to solve such problems, an object of a device 100 and method for providing movement guidance based on road structure recognition according to embodiments of the present disclosure is to check a surrounding road structure and direction based on sensor information without depending on a precise map and to provide a user with guidance to a movement direction based on the orientation of the user. Accordingly, user experiences similar to the utilization of a trained guide dog can be provided, and a movement of a person who is visually impaired can be effectively supported.

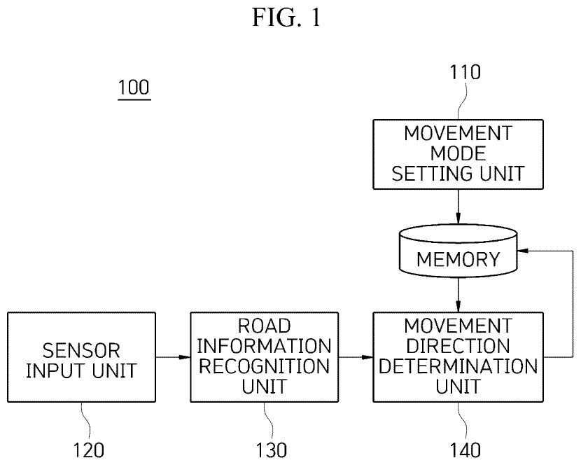

Hereinafter, the device 100 for providing movement guidance based on road structure recognition according to an embodiment of the present disclosure is described with reference to FIGS. 1 to 8.

FIG. 1 is a block diagram of the device 100 for providing movement guidance based on road structure recognition (hereinafter referred to as the “movement guidance device”) according to an embodiment of the present disclosure.

The movement guidance device 100 according to an embodiment of the present disclosure includes a movement mode setting unit 110, a sensor input unit 120, a road information recognition unit 130, and a movement direction determination unit 140.

First, the movement mode setting unit 110 sets a movement mode corresponding to orientation indication that is input by a user. In this case, the orientation indication is abstracted direction indication that is used for a human being to go along a road, and may include “forward”, “to a left path”, “to a right path”, and a “stop”, for example. The type of possible orientation indication needs to be previously defined. The movement mode setting unit 110 may receive the orientation indication from a user through a voice input, a button, or a key value input.

The input orientation indication is preferably recorded as a movement mode without any change. The input needs to be immediately incorporated into a system. Accordingly, orientation indication that is newly input is replaced with a new movement mode without any change regardless of the existing movement mode. Through the orientation indication, the command of a user is rapidly incorporated, so the movement guidance device 100 can immediately respond based on a movement direction and behavior desired by the user.

Next, the sensor input unit 120 receives three-dimensional (3-D) depth sensing data and converts the 3-D depth sensing data into a depth image. Sensors that are representatively used in order to perform such a function include LiDAR and RGBD sensors.

The RGBD sensor provides depth data at a limited viewing angle ahead, whereas the LiDAR may provide depth data in a 360-degree direction (surround) direction. It is preferred that the LiDAR sensor capable of providing a depth in the 360-degree surround direction is used because up to left and right directions in addition to the front need to be considered in order to determine a road structure and a road direction. However, in recognizing a road structure and a road direction that are presented in an embodiment of the present disclosure, the LiDAR sensor is not essentially limitedly used. The RGBD sensor may be used along with or separately from the LiDAR sensor.

For reference, the LiDAR sensor may be divided into single channel LiDAR and multi-channel LiDAR. In the past, the single channel LiDAR was used. However, recently, multi-channel LiDAR, including 32 channels, 64 channels, and 128 channels, is commonly used. The single channel LiDAR measures a distance up to a surrounding object (or obstacle) while rotating a ray 360 degrees in a horizontal direction (tilt=0) centering around a sensor. In contrast, the multi-channel LiDAR may obtain 360-degree scans simultaneously for multiple tilt angles in addition to a horizontal direction (tilt=0).

A horizontal viewing angle of a LiDAR sensor in the multi-channel LiDAR is 360 degrees, and a vertical viewing angle thereof is a difference between the tilt angles of the lowest channel and the highest channel. Furthermore, a difference between the tilt angles of adjacent channels is called vertical angular resolution. A data interval within one channel is called horizontal angular resolution. For example, a total number of data of a 64-channel LiDAR sensor having horizontal angular resolution of 0.5 degree is (360/0.5)*64=46,080.

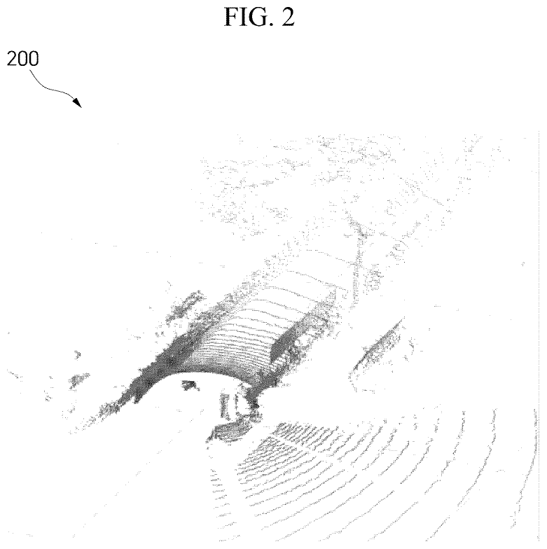

FIG. 2 is a diagram illustrating an example of LiDAR sensor data.

In the robot field, LiDAR sensor data are represented and used in a point cloud form 200 as illustrated in FIG. 2. A human being can check a space structure in a data representation of the point cloud form 200, but it is not easy for a computer algorithm to check the space structure by analyzing the data representation of the point cloud form. In order to solve such a problem, in an embodiment of the present disclosure, LiDAR sensor data are converted into a depth image 300. The depth image is used to recognize a road structure, without using the LiDAR sensor data as the point cloud form 200.

As an embodiment, in a process of converting 3-D depth sensing data into the depth image 300, first, the y coordinates of an image are set based on the number of channels of each of LiDAR sensors. Furthermore, the x coordinates of the image are set based on the number of data per channel. Furthermore, the intensity of an image pixel may be set so that the intensity is in reverse proportion to a distance value that is measured by a beam, and the 3-D depth sensing data may be converted into the depth image 300. That is, an object at a closer distance is indicated as brighter pixels, and an object at a farther distance is indicated as darker pixels. Through such a process, the 3-D depth sensing data are converted and visualized in the form of the depth image 300. Accordingly, depth information of an environment that is measured by LiDAR can be visually understood and analyzed.

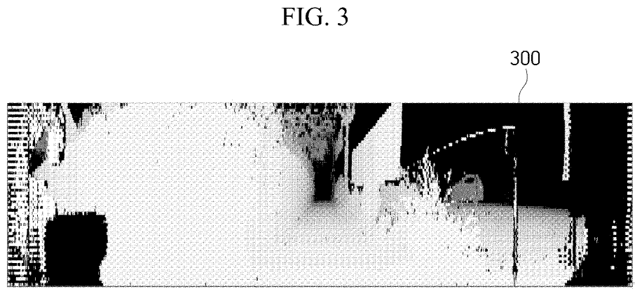

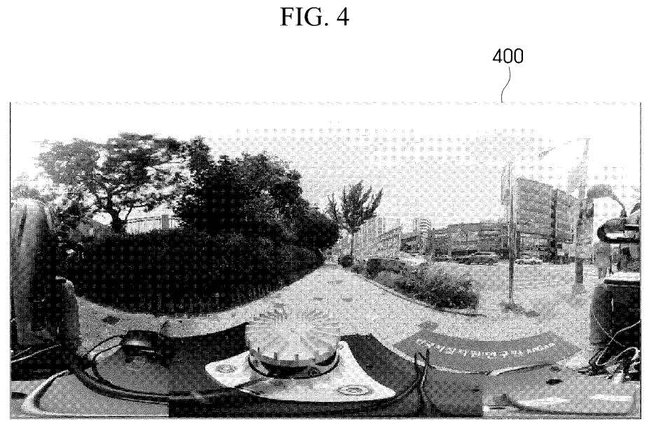

FIG. 3 is a diagram illustrating an example in which 3-D LiDAR sensing data are converted into the depth image 300. FIG. 4 is a diagram illustrating an example of a 360-degree RGB image 400. In this case, FIG. 4 illustrates the 360-degree RGB image 400 that was captured at the same location and same time as those in FIG. 2.

In the depth image 300 of FIG. 3, the height of the image is the same as the number of channels of LiDAR, and the width of the image is the same as the number of data per channel. The reason for this is that data are generated for each channel because the LiDAR sensor measures an environment by radiating several beams in vertical and horizontal directions and thus the size of an image is determined.

Furthermore, the x coordinates of the depth image 300 correspond to a horizontal direction angle (i.e., a pan angle) of each beam, and the y coordinates thereof correspond to a horizontal direction angle (i.e., a tilt angle). The reason for this is that the LiDAR sensor generates the depth image 300 by mapping data, which are measured by radiating beams in the vertical and horizontal directions, to a coordinate plane.

Furthermore, the intensity of each pixel is in reverse proportion to a distance from an object at a corresponding direction angle. That is, the closer the distance to the object is, the brighter the pixel is displayed, and the farther the distance to the object is, the darker the pixel is displayed.

Referring back to FIG. 1, the road information recognition unit 130 recognizes information on the structure and direction of a road from a depth image. As an embodiment, the road information recognition unit 130 detects an open space in the depth image, and determines whether at least one of a left boundary or a right boundary in the depth image neighbors a blocked region having a predetermined width or more. Furthermore, if at least one of the left boundary or the right boundary neighbors the blocked region as a result of the determination, the road information recognition unit 130 may detect an open space that neighbors a depth increase direction of the blocked region as a road region.

In this case, the open space means a region that is open without being blocked by an obstacle. The blocked region is a region that is blocked by an obstacle or a blockage having a predetermined width or more, and may be defined as a space not an open space.

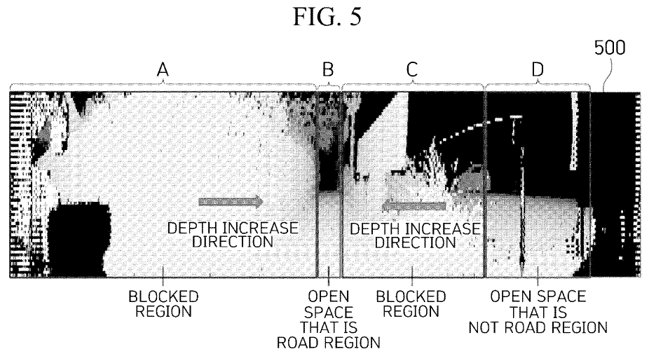

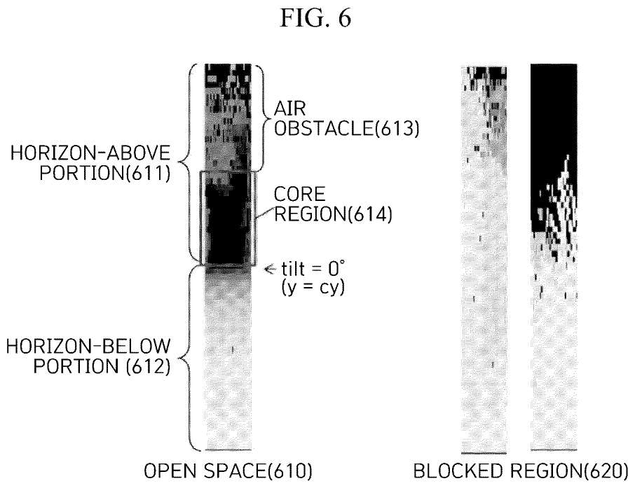

FIG. 5 is a diagram for describing a process of detecting a road region based on a depth image in an embodiment of the present disclosure. FIG. 6 is a diagram illustrating an open space and a blocked region that have been divided in an embodiment of the present disclosure.

Referring to FIG. 5, in a depth image 500, a section A and a section C correspond to blocked regions, and a section B and a section D correspond to open spaces. The section B satisfies the condition for a road region because the section B neighbors the section A, that is, a blocked region, and also neighbors the section A in the depth increase direction of the section A. Furthermore, the section B satisfies the condition for a road region because the section B neighbors the section C, that is, another blocked region, in the depth increase direction of the section C. In contrast, the section D, that is, an open space, does not satisfy the condition for a road region because the section D neighbors the section C, that is, the blocked region, but the boundary of the section D is not identical with the depth increase direction of the section C.

In the following description, a method of detecting the sections of an open space and a blocked region in a depth image and determining the direction of the blocked region is described in detail. However, a detailed method that is described in the description of the present disclosure is not essentially limited to the method, and various embodiments may be applied to the method.

As an embodiment, the road information recognition unit 130 may determine coordinates corresponding to a horizon in a depth image, and may detect, as an open space 610, a region that satisfies a first condition in which the intensity of an upper part in the depth image has a predetermined value or less and a second condition in which the intensity of a horizon-below portion is gradually increased.

Specifically, the road information recognition unit 130 may detect, as the open space 610, a case in which the intensity of an upper part (i.e., a horizon-above portion) 611 of y coordinates corresponding to the horizon in the depth image is T or less (the first condition) and a vertical line section the intensity of which is gradually increased toward a horizon-below portion 612 is present (the second condition).

In this case, in an embodiment of the present disclosure, a section having a predetermined height from the horizon may be set as a core region 614 because an air obstacle 613 may be present in the horizon-above portion 611. Furthermore, if an intensity average of the core region 614 is a predetermined value or less by checking only the intensity of the core region, it may be determined that the first condition is satisfied.

Furthermore, if LiDAR is horizontal to the ground, the y coordinates corresponding to the horizon in the depth image correspond to a channel having a tilt=0°, among the channels of the LiDAR. The y coordinates can be easily determined based on LiDAR spec. information. In this case, the y coordinates are defined as y=cy. Furthermore, the height of the core region 614 may be set as the height of an empty space through which a normal person can pass. For example, the height of the core region 614 may be set as km. In this case, a corresponding pixel height “h” of the core region 614 in the depth image may be calculated according to Equation 1 when vertical angular resolution of LiDAR is a and the depth of the core region is d meters.

$$h = {tan}^{- 1} ( \frac{k}{d} ) / α \qquad ( 1 )$$

Furthermore, the road information recognition unit 130 may basically detect a section not the open space 610 as a blocked region 620.

In an embodiment of the present disclosure, a process of detecting a depth increase direction in the blocked region 620 is as follows. The road information recognition unit 130 may first calculate an intensity average for each column of a region that is detected as the blocked region 620 in the depth image, and may determine an x-axis direction in which the intensity average is decreased as the depth increase direction. In this case, it is preferred that an intensity average of each column is calculated with respect to a lower part of y=cy that is the point of the core region 614, that is, only the horizon-below portion 612, rather than calculating an intensity average of all vertical lines (columns) in the depth image because there is a deviation between the heights of obstacles.

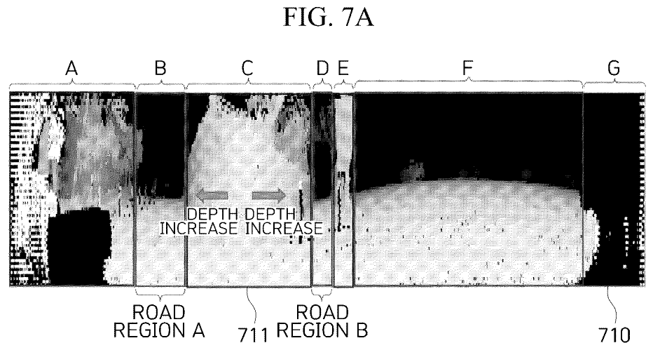

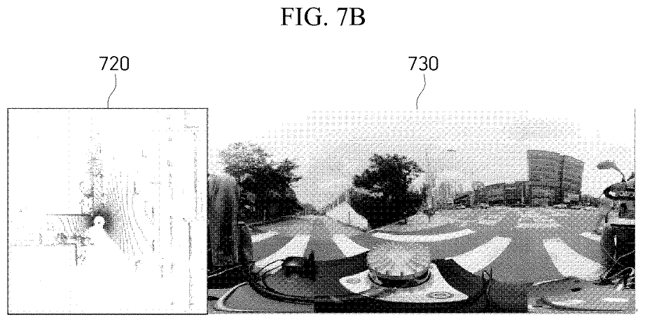

As another embodiment, there may be a case in which the depth increase direction of the blocked region 620 includes two directions on the left and right sides according to circumstances. If a region including an edge of a corner is detected as a blocked region as in a section C in FIG. 7A, a depth increase direction 711 is divided into both sides of the edge of the corner on the left and right sides thereof. In this case, the road information recognition unit 130 does not detect the depth increase direction 711 with respect to all of blocked regions, but may calculate an intensity average for each column with respect to a predetermined section that neighbors the boundary of an open space in a depth image 710, and may detect the predetermined section as a road region in which the edge of the corner is present, if an x-axis direction in which the intensity average is decreased is determined to include both directions.

Next, the road information recognition unit 130 may determine a road direction by distinguishing between a case in which both left and right sides of a road region, among detected road regions, are detected as blocked regions and a case in which only any one of the both left and right sides is detected as a blocked region.

A person who is visually impaired and a robot for assistance move along a sidewalk (or walking road). The wall of a shopping center or a building is present on any one of the left and right sides of a sidewalk, and a roadway (or road) is present on an opposite side. In this case, if the boundary of an obstacle has been formed between the sidewalk and the roadway due to street trees or a fence, blocked regions are detected on both sides of a road region in a depth image. However, if a special obstacle is not present between the sidewalk and the roadway, only the side on which the building or the shopping center is present is detected as a blocked region.

Accordingly, the road information recognition unit 130 may determine the center direction of the road region as a road direction with respect to all road regions both sides of each of which have been detected as blocked regions, among detected road regions. For example, assuming that the x coordinates of a left boundary are x1 and the x coordinates of a right boundary are x2, the x coordinates of a road direction may be calculated according to Equation 2.

$$x = ( x 1 + x 2 ) / 2 \qquad ( 2 )$$

Furthermore, if one of both sides of a detected road region is a road region that has been detected as a blocked region, the road information recognition unit 130 may determine, as a road direction, a direction at a point that has been spaced apart from the blocked region toward the road region by a predetermined distance. In this case, the distance “w” in which the road region has been physically spaced apart from the blocked region may be set as a parameter.

Accordingly, the road information recognition unit 130 may calculate the coordinates x of the spaced point based on the boundary coordinates x1 of the detected road region and the blocked region, a depth value “d” (meter) of a core region of the detected road region, and horizontal angular resolution β of a LiDAR sensor according to Equation 3.

$$x = x 1 + {tan}^{- 1} ( \frac{w}{d} ) / β \qquad ( 3 )$$

After detecting the road region through the process, the road information recognition unit 130 may determine information on the structure of the road based on the number of detected road regions and an angle between the road regions.

For example, as a first case, if the number of detected road regions is 2 and an angle between two regions is 180 degrees, the road information recognition unit 130 may determine that a user is now on a straight road. The straight road may be determined because the two regions are connected on opposite sides. As a second case, if the number of detected road regions is 2 and an angle between two regions is not 180 degrees, the road information recognition unit 130 may determine that a user is now at a corner or on a curved road. This means a situation in which a direction change is required instead of going straight because a curve or the corner is present between the two regions. Finally, if the number of detected road regions is 4 and an angle between two of all of the road regions is 90 degrees, the road information recognition unit 130 may determine that a user is now at a crossroad. This means a crossroad at which a direction needs to be selected because four regions cross each other at a right angle. If the number of detected road regions and an angle between the road regions are used as described above, information on the structure of a road can be checked.

If the horizontal viewing angle of a LiDAR sensor is limited, a determination through the aforementioned method may be difficult. For example, as illustrated in FIGS. 2 to 4, there may be a case in which data of a portion behind a LiDAR sensor are insufficient due to the blocking of an instrument to which the LiDAR sensor has been attached or another object. In such a case, it is preferred that the recognition of a road direction and a determination of a road structure are performed by excluding the corresponding portion because data of the portion behind the LiDAR sensor within a range of about 90 degrees cannot be used.

Referring back to FIG. 1, next, the movement direction determination unit 140 determines a movement direction corresponding to the movement mode based on the recognized information on the structure and direction of the road.

First, when the movement mode is a “forward” mode, this means that a user has to continue to move along a current road. The user selects a road that is most similar to a current road direction at a fork, and moves along the road. In the case of a single path not a fork, a user has to continue to go along a current road although a road is bent. Accordingly, when a current movement mode is the “forward” mode, the movement direction determination unit 140 may set a road direction that is closest to the front direction of a sensor as a movement direction. In this case, the front direction of the sensor is set as a direction corresponding to the center of the left and right of a depth image. If the width of the depth image is W, the front direction of the sensor is set as a direction in which x coordinates are x=W/2.

The road direction that has been selected as described above is set as a movement direction. A user continues to move in a corresponding direction in the “forward” mode. Through such a process, the user continues to go along a current road, and may select a road that is most similar to the current road even at a fork and move along the road.

Next, when a current movement mode is a “to-a-left-road” mode, a user has to go along a current road and then to move to a left road at a fork that first appears. Thereafter, the user has to continue to move forward along the corresponding road. Accordingly, the movement mode needs to be changed into the “forward” mode. Such an operation may be performed so that the movement mode is automatically changed as the movement mode is changed into the “to-a-left road” mode and a movement is completed.

As an embodiment, when the number of detected road directions is 1 in the “to-a-left-road” mode, the movement direction determination unit 140 may set a detected road direction as a movement direction. When the number of detected road directions is 2 or more, the movement direction determination unit 140 may set a leftmost road direction, among the detected road directions, as a movement direction. Furthermore, the movement direction determination unit 140 may change a movement mode that has been stored in memory into the “forward” mode.

Next, when a current movement mode is a “to-a-right road” mode, the user has to go along a current road and then to move to a right road at a fork that first appears. Thereafter, the user has to continue to move forward along the corresponding road. Accordingly, the movement mode needs to be changed into the “forward” mode. Such an operation may be performed so that the movement mode is automatically changed as the movement mode is changed into the “to-a-right road” mode and a movement is completed.

As an embodiment, when the number of detected road directions is 1 in the “to-a-right road” mode, the movement direction determination unit 140 may set a detected road direction as a movement direction. When the number of detected road directions is 2 or more, the movement direction determination unit 140 may set a rightmost road direction, among the detected road directions, as a movement direction. Furthermore, the movement direction determination unit 140 may change a movement mode that has been stored in the memory into the “forward” mode.

Next, when a current movement mode is a “stop” mode, the movement direction determination unit 140 does not generate a movement direction.

All of recognition systems always have the possibility of a recognition error or failure, but the failure may be temporary. Accordingly, when the recognition of a road structure or a road direction fails, the movement direction determination unit 140 may continue to maintain the most recent movement direction without immediately stopping the entire device. That is, when the number of continuous recognition failures is a predetermined number of times or less, that is, n times or less, the movement direction determination unit 140 maintains the most recent movement direction without any change regardless of a current movement mode so that a user continues to move in a movement direction that has been previously set. In contrast, when the number of continuous recognition failures is greater than a predetermined number of times, that is, n times, the movement direction determination unit 140 may notify the user of a recognition failure and change a current movement mode into the “stop” mode. In this case, the movement direction determination unit 140 may output a proper warning message in order to notify the user of the recognition failure.

In an embodiment of the present disclosure, it is assumed that a user has the self-orientation ability. Accordingly, when a system fails, a user can continue to move through a user's manual manipulation or forced “forward” command until the recognition of the system is recovered.

In addition, in an embodiment of the present disclosure, if the movement guidance device 100 has been implemented as a robot, a distance between the robot and a user may be measured and stored. When the user moves at a corner or on a curved road based on the measured distance, the curvature radii of the user and the robot may be differently calculated. Accordingly, although a movement mode is the “forward” mode, the user may move along a curved road by considering a curvature radius that is calculated in real time.

Furthermore, in an embodiment of the present disclosure, when a user moves in the same area, faster user guide may be made possible if the user moves in the same area in plural rounds based on information on the structure and direction of a road that has been previously stored. That is, when the user moves in the same area in the first round, the information on the structure and direction of the road is stored. When the user moves in the same area in the second round, the information stored in the first round may be read, but only a mismatching part between the first and second rounds may be separately detected and used as recognition information. In this case, the mismatching part may be a part that satisfies a predetermined size or more.

Furthermore, an embodiment of the present disclosure may be extended to enable movement guidance by combining additional information although a user falls outside the structure of a common road. A case in which a user falls outside the structure of a common road may include a case in which a user uses a crosswalk in order to cross a roadway, a case in which a user uses an elevator, an escalator, or a staircase, and a case in which a user moves to an entrance or a gate, for example. In this case, the orientation indication of the user may be extended to include “to a crosswalk” “to a staircase”, “to an elevator”, etc. Furthermore, in the case of additional orientation indication, a crosswalk or a staircase may be detected by using an RGB image of the RGBD sensor or an additional camera image in addition to a depth image. The direction of a detected region may be set as a road direction or a movement direction. In order to identify an object region in the RGB image, a conventional image semantic segmentation technology may be used.

FIGS. 7A and 7B are diagrams illustrating the depth image 710, a LiDAR point cloud data graph 720, and a 360-degree RGB image 730 in an embodiment of the present disclosure. In FIG. 7B, the LiDAR point cloud data graph 720 and the 360-degree RGB image 730 are together illustrated to help understanding of the depth image 710.

In the depth image 710, a section B and a section D are detected as road regions because the section B and the section D satisfy all of the aforementioned conditions for a road region. In contrast, a section F is an open space and neighbors a section E that is a blocked region, but is not classified as a road region because it is difficult to consider the section E as a blocked region having a sufficient width. In this case, a criterion for the sufficient width may be adjusted based on the aforementioned parameter.

The example of FIG. 7A is a case in which two road regions (i.e., a road region A and the road region B) are detected and an angle between the two road regions is about 90 degrees. In this case, it may be determined that a fork having an alley to the left is present. If a current movement mode is the “forward” mode, a movement direction may be set as the center direction of the section D. If a current movement mode is the “to-a-left road” mode, a movement direction may be set as the center direction of the section B.

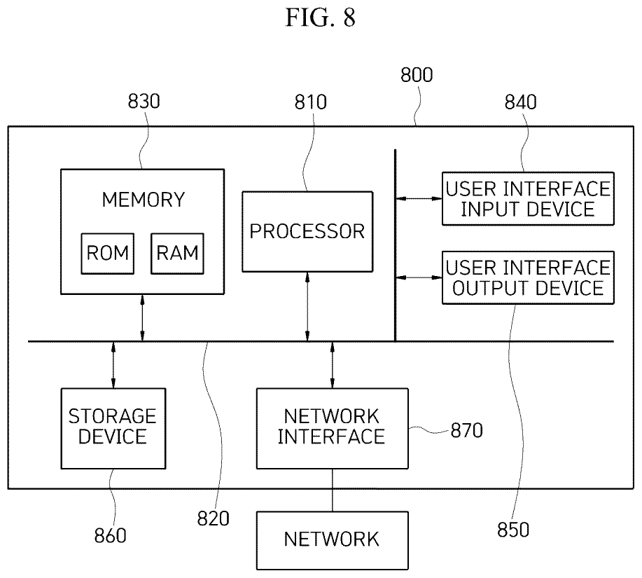

FIG. 8 is a block diagram of the movement guidance device 100 according to an embodiment of the present disclosure.

The movement guidance device 100 according to an embodiment of the present disclosure may consist of a computing device 800. The computing device 800 may include at least one of a processor 810, memory 830, a user interface input device 840 (or an input unit), a user interface output device 850, and a storage device 860, which communicate with each other through a bus 820. The computing device 800 may further include a network interface 870 (or a communication unit) that is electrically connected to a network, for example, a wireless network. The network interface 870 may transmit or receive data to or from another network entity over the network.

The processor 810 may be implemented by various types, such as an application processor (AP), a central processing unit (CPU), and a graphic processing unit (GPU), and may be an arbitrary semiconductor device that executes an instruction stored in the memory 830 or the storage device 860. The processor 810 may be configured to implement the functions and methods that have been described with reference to FIGS. 1 to 7 and 8.

The memory 830 and the storage device 860 may each include various forms of volatile or nonvolatile storage media. For example, the memory may include read-only memory (ROM) and random access memory (RAM). In an embodiment of the present disclosure, the memory 830 may be disposed inside or outside the processor 810. The memory 830 may be connected to the processor 810 through various means that have already been known.

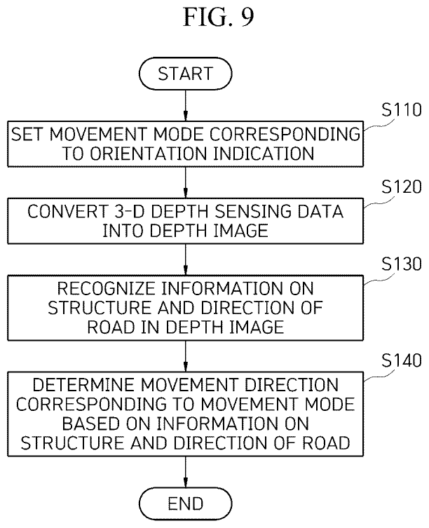

FIG. 9 is a flowchart of a movement guidance method according to an embodiment of the present disclosure. In this case, steps illustrated in FIG. 9 may be understood as being performed by the movement guidance device 100, but the present disclosure is not essentially limited thereto.

First, a movement mode corresponding to orientation indication that is input by a user is set (S110).

Next, when 3-D depth sensing data are received from the LiDAR sensor, the 3-D depth sensing data are converted into a depth image (S120).

Next, information on the structure and direction of a road is recognized in the depth image (S130). A movement direction corresponding to the movement mode is determined based on the recognized information on the structure and direction of the road (S140).

In the aforementioned description, each of steps S110 to S140 may be further divided into additional steps or the steps may be combined into smaller steps depending on an implementation example of the present disclosure. Furthermore, some of the steps may be omitted, if necessary, and the sequence of the steps may be changed. Furthermore, although contents are omitted, the contents of FIGS. 1 to 8 may also be applied to the method of generating signal images in FIG. 9.

The movement guidance device 100 and the method thereof according to embodiments of the present disclosure may be implemented in the form of a program (or application) in order to be executed by being combined with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. That defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include ROM, RAM, CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

What is claimed is:

1. A method of providing movement guidance based on road structure recognition, the method comprising:
setting a movement mode corresponding to orientation indication that is input by a user;
converting, into a depth image, three-dimensional (3-D) depth sensing data that have been input;
recognizing information on a structure and direction of a road in the depth image; and
determining a movement direction corresponding to the movement mode based on the recognized information on the structure and direction of the road.

2. The method of claim 1, wherein the converting of, into the depth image, the three-dimensional (3-D) depth sensing data that have been input comprises converting the 3-D depth sensing data into the depth image by setting y coordinates of an image based on a number of channels of each LiDAR sensor, setting x coordinates of the image based on a number of data per channel, and setting an intensity of an image pixel so that the intensity is in reverse proportion to a distance value that is measured in a beam.

3. The method of claim 1, wherein the recognizing of the information on the structure and direction of the road in the depth image comprises:
detecting an open space in the depth image;
determining whether at least one of a left boundary or right boundary of the open space in the depth image neighbors a blocked region having a predetermined width or more; and
detecting an open space that neighbors a depth increase direction of the blocked region, as a road region, when at least one of the left boundary or the right boundary neighbors the blocked region as a result of the determination.

4. The method of claim 3, wherein the detecting of the open space in the depth image comprises:
determining coordinates corresponding to a horizon in the depth image; and
detecting, as an open space, a region that satisfies a first condition in which an intensity of a horizon-above portion is a predetermined value or less and a second condition in which an intensity of a horizon-below portion is gradually increased.

5. The method of claim 4, further comprising setting a section having a predetermined height from the horizon as a core region,
wherein the detecting of, as the open space, the region that satisfies the first condition in which the intensity of the horizon-above portion is the predetermined value or less and the second condition in which the intensity of the horizon-below portion is gradually increased comprises determining that the first condition is satisfied when an intensity average of only the core region is the predetermined value or less.

6. The method of claim 5, wherein the setting of the section having the predetermined height from the horizon as the core region comprises calculating a pixel height of the core region based on vertical angular resolution of the LiDAR sensor and depth information of the core region.

7. The method of claim 3, wherein the detecting of the open space that neighbors the depth increase direction of the blocked region, as the road region comprises:
calculating an intensity average for each column that is detected as a blocked region in the depth image; and
determining an x-axis direction in which the intensity average is decreased as the depth increase direction.

8. The method of claim 7, wherein the calculating of the intensity average for each column that is detected as the blocked region in the depth image comprises calculating the intensity average of each column with respect to only a ground section that is a lower part of the core region.

9. The method of claim 3, wherein the detecting of the open space that neighbors the depth increase direction of the blocked region, as the road region comprises:
calculating an intensity average for each column with respect to a predetermined section that neighbors a boundary with the open space in the depth image; and
detecting the predetermined section as a road region in which an edge of a corner is present when an x-axis direction in which the intensity average is decreased comprises both directions.

10. The method of claim 3, wherein the recognizing of the information on the structure and direction of the road in the depth image comprises determining a center direction of a road region both sides of which are detected as blocked regions, among the detected road regions, as a road direction.

11. The method of claim 3, wherein the recognizing of the information on the structure and direction of the road in the depth image comprises determining a direction at a point that is spaced apart from a blocked region toward a road region by a predetermined distance, as a road direction, when the road region is a road region one side of which is detected as the blocked region, among detected road regions.

12. The method of claim 11, wherein the recognizing of the information on the structure and direction of the road in the depth image comprises calculating coordinates of the spaced point, based on coordinates of a boundary between the detected road region and the blocked region, a depth value of a core region of the detected road region, and horizontal angular resolution of a LiDAR sensor.

13. The method of claim 3, wherein the recognizing of the information on the structure and direction of the road in the depth image comprises determining information on the structure of the road based on a number of detected road regions and an angle between the road regions.

14. A device for providing movement guidance based on road structure recognition, the device comprising:
a movement mode setting unit configured to set a movement mode corresponding to orientation indication that is input by a user;
a sensor input unit configured to receive three-dimensional (3-D) depth sensing data and to convert the 3-D depth sensing data into a depth image;
a road information recognition unit configured to recognize information on a structure and direction of a road in the depth image; and
a movement direction determination unit configured to determine a movement direction corresponding to the movement mode based on the recognized information on the structure and direction of the road.

15. A device for providing movement guidance based on road structure recognition, the device comprising:
an input unit configured to receive orientation indication from a user;
a communication unit configured to receive three-dimensional (3-D) depth sensing data from a predetermined sensor;
memory in which a program for providing guidance to a movement of the user has been stored based on the orientation indication; and
a processor configured to set a movement mode corresponding to the orientation indication, convert the 3-D depth sensing data into a depth image, recognize information on a structure and direction of a road in the depth image, and determine a movement direction corresponding to the movement mode based on the recognized information on the structure and direction of the road.
